(19) United States
(12) Patent Application Publication
(10) Pub. No.: US 2023/0161919 A1
(43) Pub. Date: May 25, 2023

(54) LOGIC LOCKING WITH RANDOM KEY

(71) Applicant: International Business Machines Corporation, Armonk, NY (US)

(72) Inventor: Effendi Leobandung, Stormville, NY (US)

(21) Appl. No.: 17/533,194

(22) Filed: Nov. 23, 2021

(51) Int. Cl. G06F 21/73; H04L 9/08; G06K 19/06; G01R 31/28

(52) U.S. Cl. CPC G06F 21/73; H04L 9/0866; G06K 19/06028; G01R 31/2831

(57) ABSTRACT

Aspects of the invention include measuring, by a processor, characteristic data of a structure in a first die of a wafer during fabrication, wherein the characteristic data of the structure comprises a current or capacitance measurement in the structure, recording the current or capacitance measurement as an internal chip fingerprint key for the first die, causing, by the processor, completion of fabrication of the first die in the wafer, wherein the first die comprises a hashing engine and a logic lock, generating a die ID for the first die based on the internal chip fingerprint key for the first die, generating a first external key based on the die ID and the hash engine, and inputting the first external key into the first die to unlock the first die, wherein the first external key hashed with the internal chip fingerprint key creates an unlocking key for the logic lock.

### BACKGROUND

The present invention generally relates to integrated circuit (IC) security, and more specifically, to logic locking using random keys.

As the complexity of fabrication of integrated circuits (IC) continues to increase, many IC designers operate without associated foundries and instead utilize foundries that are outside their control, possibly in other locations around the world. With the fabrication of ICs outside the control of the owners of the ICs, the possibility of counterfeiting, reverse engineering, and intellectual property (IP) piracy exists. Additionally, third party foundries can overproduce ICs and sell these ICs on the market.

Because of the above mentioned risks, IC designers utilize logic locking to protect their ICs. Logic locking is a technique to manipulate a given combinational circuit with an added key input to help ensure that the encryption circuit will only function as the original one under a specific key value that is difficult to obtain or figure out. Logic encryption can be used for IP protection, IC production control, Trojan prevention, to prevent reverse engineering, and many other applications in hardware security. Circuit camouflaging, or obfuscation, refers to a technique in which ambiguity is intentionally introduced in the layout to make reverse-engineering difficult or impossible. Such circuit camouflaging can also be modeled as logic encryption with keys to encode different possibilities. Despite the advances in logic locking and obfuscation techniques, integrated circuits are still susceptible to theft when the logic key is compromised.

### SUMMARY

Embodiments of the present invention are directed to a method for logic locking an integrated circuit. A non-limiting example method includes measuring, by a processor, characteristic data of a structure in a first die of a wafer during fabrication, wherein the characteristic data of the structure includes a current or capacitance measurement in the structure, recording the current or capacitance measurement as an internal chip fingerprint key for the first die, causing, by the processor, completion of fabrication of the first die in the wafer, wherein the first die includes a hashing engine and a logic lock, generating a die identification (ID) for the first die based on the internal chip fingerprint key for the first die, generating a first external key based on the die ID and the hash engine for the first die, and inputting the first external key into the first die to unlock the first die, wherein the first external key hashed with the internal chip fingerprint key creates an unlocking key for the logic lock for the first die.

Other embodiments of the present invention implement features of the above-described method in computer systems and computer program products.

Additional technical features and benefits are realized through the techniques of the present invention. Embodiments and aspects of the invention are described in detail herein and are considered a part of the claimed subject matter. For a better understanding, refer to the detailed description and to the drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the invention are apparent from the following detailed description taken in conjunction with the accompanying drawings in which:

FIG. 1 depicts a block diagram of a process flow from design to production to delivery to an end user for an IC;

FIG. 2a depicts an exemplary logic circuit with an added logic locking using XNOR and XOR gates requiring a key value for a valid output;

FIG. 2b depicts an exemplary logic circuit with an added logic locking using XNOR and XOR gates requiring a key value for a valid output;

FIG. 3 depicts a system for unlocking a logic locked integrated circuit (IC) is generally shown in accordance with one or more embodiments of the present invention;

FIG. 4 depicts an exemplary fingerprint key chip element according to one or more embodiments of the present invention;

FIG. 5 depicts a flow diagram of a method for logic locking according to one or more embodiments of the invention;

FIG. 6 depicts a flow diagram of a method for logic locking according to one or more embodiments of the invention; and

FIG. 7 depicts a block diagram of a computer system in accordance with an embodiment of the invention.

The diagrams depicted herein are illustrative. There can be many variations to the diagrams or the operations described therein without departing from the spirit of the invention. For instance, the actions can be performed in a differing order or actions can be added, deleted or modified. Also, the term “coupled” and variations thereof describes having a communications path between two elements and does not imply a direct connection between the elements with no intervening elements/connections between them. All of these variations are considered a part of the specification.

### DETAILED DESCRIPTION

One or more embodiments of the present invention provides for logic locking of integrated circuits (IC) where a unique key is assigned to each IC during fabrication using a chip fingerprint that is unique to the specific IC.

Logic locking refers to mechanisms which hide the functionality and the implementation of an IC by including additional gates into the design of the IC. In order for the IC to function as intended, a valid key must be supplied to the locked IC. The additional gates included in the design of the IC can be referred to as so called key gates. If an invalid key is supplied to the locked design, the IC will not function as intended (i.e., will produce incorrect outputs). The key gates are typically implemented by inserting logic gates into a logic circuit design on an IC. The logic gates require an appropriate key value (e.g., 0 or 1) to allow for the logic circuit to produce the correct output. Post fabrication, the keys are activated and stored in a tamper-evident memory inside the IC design to prevent access to an attacker, rendering these key-inputs inaccessible by an attacker.

Despite the above mentioned measures taken to protect an IC from attacks, logic locking techniques can still be susceptible to new attacks such as piracy, overbuilding or reverse engineering.

A common practice for logic locking includes the formulation of one key that is common for all dies for the same IC design. This can result with all dies being compromised if this one key is compromised. One or more embodiments of the present invention provide for a key that is unique for each IC where the key is derived from a so called chip fingerprint. This protects each IC that is cast from a die should a single key be compromised.

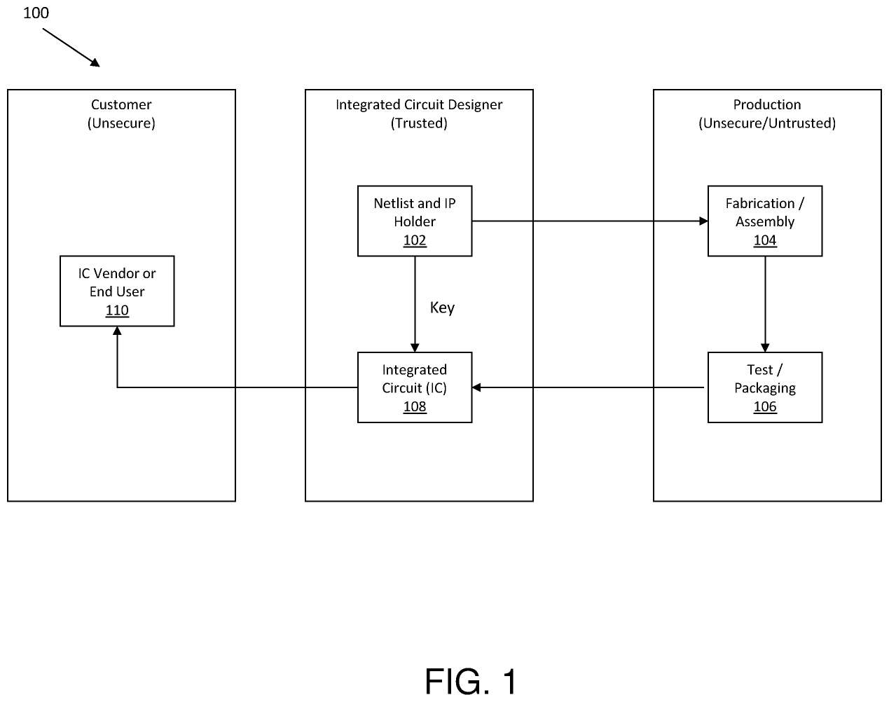

Most IC designers outsource the physical production, assembly, and/or testing of their ICs to service providers all over the world. FIG. 1 depicts a block diagram 100 of a process flow from design to production to delivery to an end user for an IC. The IC designer holds the netlist and IP 102 for the IC and provides this netlist to the production side. The production side includes the fabrication and assembly stage 104 and the testing and packaging stage 106 before returning the manufactured IC 108 back to the designer. At this time, the IC 108 is locked when returned back to the IC designer. The IC designer supplies a key to the IC 108 before supplying the IC to an IC vendor and/or end user 110. Because the Production and Customer stages are outside the control of the IC designer stage, these stages are considered unsecure and/or untrusted. As such, the key for each IC is not shared with the production companies and the production companies return a locked IC backed to the IC designer. The IC designer can unlock these ICs 108 using the key and provide these unlocked ICs 108 to the customer.

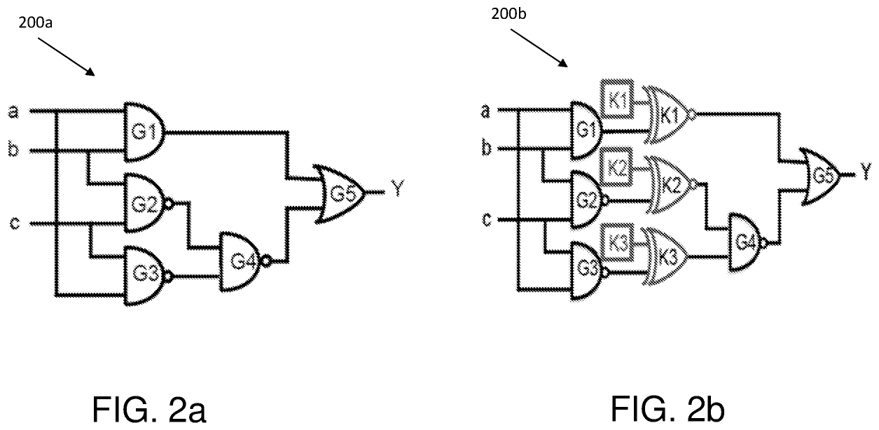

FIGS. 2a and 2b depict exemplary logic circuits with an added logic locking using XNOR and XOR gates requiring a key value for a valid output. As shown in FIG. 2a, the initial logic circuit 200a includes a grouping of AND gates and NAND gates as well as an OR gate. The inputs are a, b, and c with an output of Y. As shown in FIG. 2b, the logic locked circuit 200b includes two XNOR gates and one XOR gate that each require a specific input of key values (K1, K2, K3) to derive a correct output Y. The key values (K1, K2, K3) are binary values (0, 1). As seen, if the key values are incorrect, the output Y will be invalid/incorrect thus rendering the logic circuit to be defective. While only three new gates for three key values are shown, any number of logic gates can be added in any number of locations of a circuit with each requiring a specific key value for valid outputs.

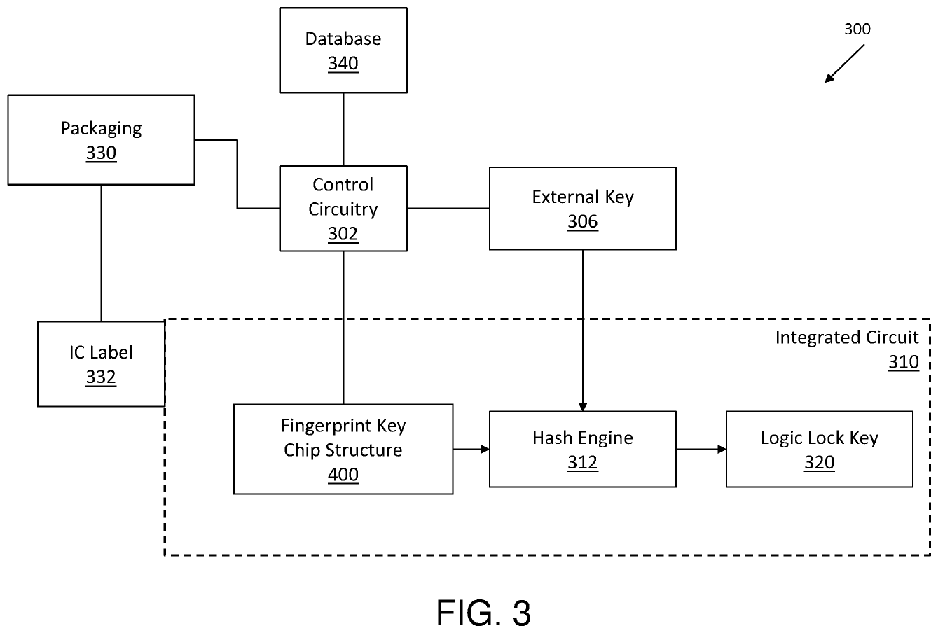

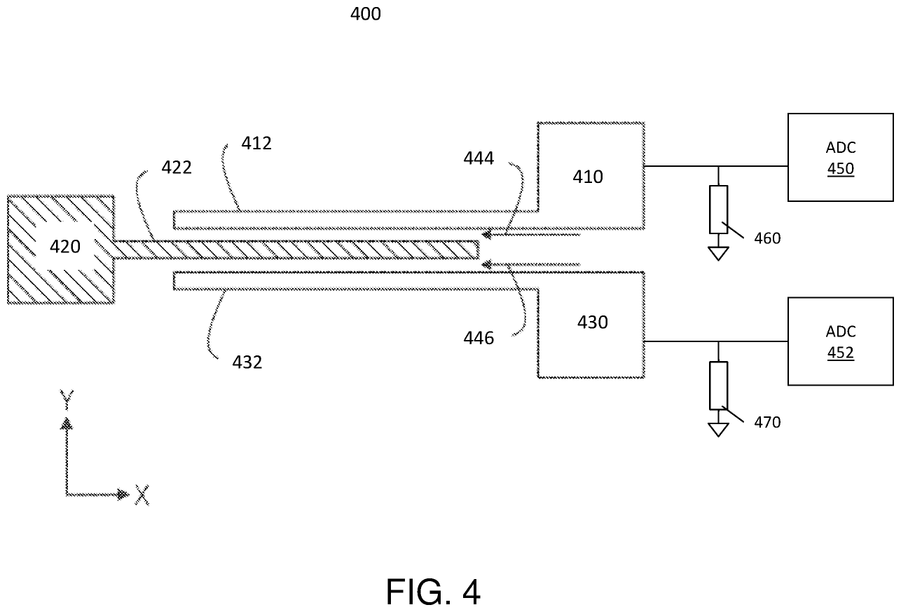

Turning now to FIG. 3, a system 300 configured to unlock a logic locked integrated circuit (IC) is generally shown in accordance with one or more embodiments of the present invention. The system 300 includes an IC 310 that is fabricated by a fabrication company. The integrated circuit 310 includes a hash engine 312 and a fingerprint key chip structure 400 that are placed on the IC 310 during fabrication. Also, during fabrication, a control circuitry 302 is configured to measure one or more characteristics of the fingerprint key chip structure 400 prior to the completion of the fabrication. The one or more characteristics of the fingerprint key chip structure 400 will be discussed in greater detail with reference to FIG. 4 below. The one or more characteristics are measured by the control circuitry 302 and, optionally, converted to a different numerical format such as, for example, a binary number and stored in a secure database 340. These one or more characteristics can be referred to as an internal chip fingerprint key. Based on this internal chip fingerprint key, the control circuitry 302 operates a packaging module 330 to place an IC label 332 on the IC 310. The IC label 332 is based on this internal chip fingerprint key and can be in any format such as, for example, a barcode and/or an e-Fuse. The database 340 stores the internal chip fingerprint key and associates this key with the IC label 332. The IC label 332 is placed after the fabrication of the IC 310. The control circuitry 302 generate an external key 306 that is configured to hash 312 with the internal chip fingerprint key to generate the logic lock key 320 that unlocks the IC 310. The external key 306 can be generated by the control circuitry 302 and provided to a customer that has purchased the locked IC 310.

FIG. 4 depicts an exemplary fingerprint key chip element according to one or more embodiments of the present invention. The fingerprint key chip structure 400 includes a structure on a wafer (not shown) that includes a first metal layer. In an embodiment, the first metal layer is a conductive layer that has a first patterned layer in the X direction consisting of lines 412 and 432 and a second patterned layer in the X direction including line 422. In an embodiment, each line 412, 422, 432 has a conductive terminal 410, 420, 430, respectively, connected to each line.

In one or more embodiments of the present invention, one or more of the structure described in FIG. 4 can be included in an integrated circuit that is locked using logic locking. While fabrication techniques have become very precise, there will be variations in the Y distance between the side of line 412 and line 422, as shown by distance 444 and the Y distance between the side of line 432 and the side of line 422, as shown by distance 446. In an embodiment, a first analog to digital converter (ADC) 450 is connected to terminal 410 and a second ADC 452 is connected to terminal 430. A voltage ramp, for example, can be applied to terminal 420 using either a probe from an outside the wafer or from some circuit that supplies voltage to the terminal. As the voltage ramp is increased on terminal 420, electricity is conducted between line 412 and line 422, and in between line 432 and line 422. The current going through resistor 460 and resistor 470 will generate analog voltage for the first ADC 450 and the second ADC 452 and these voltages can be recorded. The binary representation of the voltages are aggregated together with many similar structures, in multiple location on the chips, and at multiple levels, to generate the fingerprint key, which will be used by the control circuitry 302 (from FIG. 3) Instead of current and resistance, capacitance can also be measured between insulator gap 444 and 446 to generate the fingerprint key. As mentioned above, the variation in the distances 444 and 446 during the fabrication process from other structures will make this current or capacitance value essentially unique to the specific structure. This structure is the fingerprint key chip structure 400. As mention above, the current or capacitance value can be converted to a format that can be received by the hash engine 312 (from FIG. 3) along with the external key 306 to output the logic lock key 320 that unlocks the IC 310.

After fabrication and before providing the IC 310 to a customer and/or IC vendor, the IC designer 350 can access the database 340 to obtain the internal chip fingerprint key and generate an external key 306 that is unique to the IC 310. The external key 306 can be inputted into the IC 310 and hashed 312 with the internal chip fingerprint key to determine the correct logic lock key 320 that allows for valid operation of the IC 310.

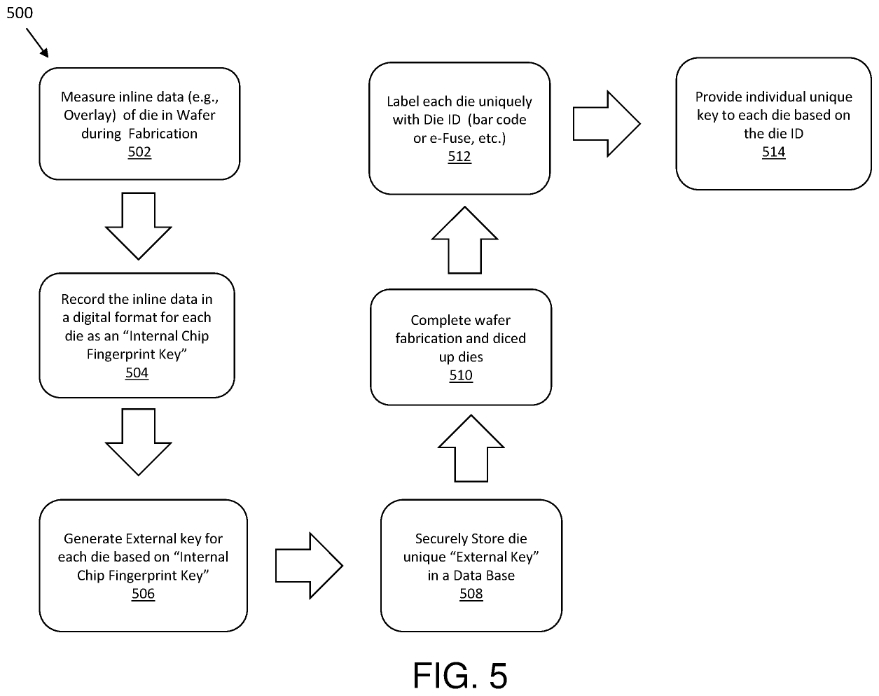

FIG. 5 depicts a flow diagram of a method for logic locking according to one or more embodiments of the invention. The method 500 includes measuring the inline data (e.g., overlay) of a die in the wafer during fabrication of one or more dies, as shown in block 502. The inline data refers to the current or capacitance measurement taken from a structure 400 in the die described in FIG. 4. At block 504, the method 500 includes recording the inline data in a digital format for each die on the wafer as an internal chip fingerprint key. Each die can have a unique internal chip fingerprint key due to the unique measurement taken from the structure 400 in each of the die. In one or more embodiments of the invention, one or more structures 400 can be fabricated on each die where the internal chip fingerprint can be derived from multiple inline data measurements taken from multiple structures 400 on a single die. The method 500 also includes generating an external key for each die based on the internal chip fingerprint key, as shown in block 506. The method 500 also includes securely storing the external key in a database for each die, as shown in block 508. At block 510, the method 500 includes completing the fabrication of the wafer and dicing up the dies in the wafer. Then, at block 512, the method 500 includes labeling each die with a die identification (ID) which is associated with the internal chip fingerprint key. The die ID can be a bar code and/or an e-Fuse associated with the die. At this point, the owner of the die and not the fabrication company has control of the external key and the internal chip fingerprint key and can differentiate each die to provide the means for unlocking the die. The locked die is returned to the die owner to provide to a customer/vendor. The method 500 continues by including providing the individual unique key to each die based on the die ID, as shown at block 514. This unlocks the die for the customer. In this sense, if the key for a specific die is known and/or compromised, the other dies cannot be compromised due to the uniqueness of each unlocking die key.

Additional processes may also be included. It should be understood that the processes depicted in FIG. 5 represent illustrations, and that other processes may be added or existing processes may be removed, modified, or rearranged without departing from the scope and spirit of the present disclosure.

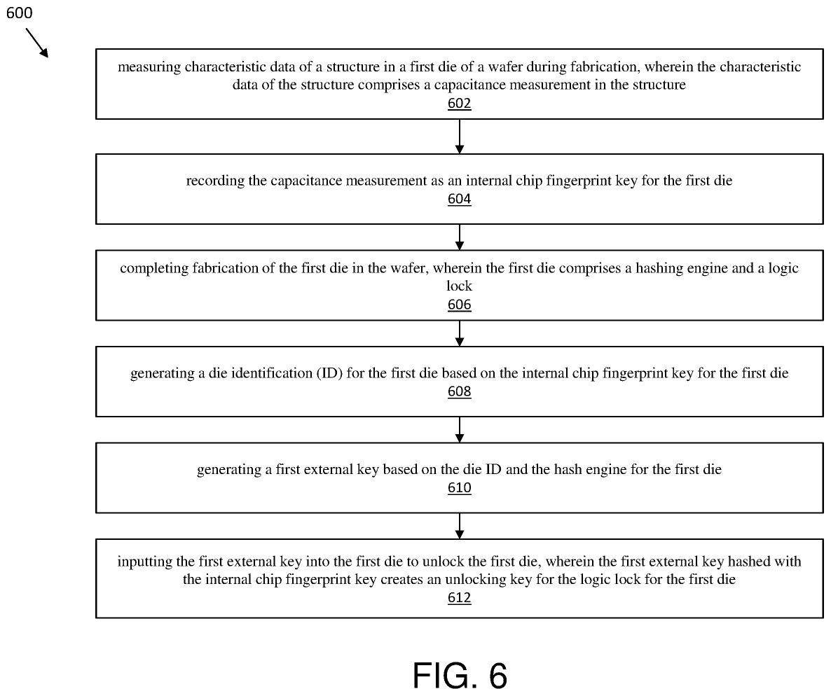

FIG. 6 depicts a flow diagram of a method for logic locking according to one or more embodiments of the invention. The method 600 includes measuring characteristic data of a structure in a first die of a wafer during fabrication, wherein the characteristic data of the structure comprises a capacitance measurement in the structure, as shown in block 602. At block 604, the method 600 includes recording the capacitance measurement as an internal chip fingerprint key for the first die. Also, the method 600, at block 606, includes completing fabrication of the first die in the wafer, wherein the first die comprises a hashing engine and a logic lock. The logic lock can include a set of added gates placed at random locations throughout the die (IC). To unlock the IC, the unlocking “key” needs to be inputted so that the logic of the IC is correct. At block 608, the method 600 includes generating a die identification (ID) for the first die based on the internal chip fingerprint key for the first die. The ID is used by the owner of the IC to determine how to create an external key for a customer. At block 610, the method 600 includes generating a first external key based on the die ID and the hash engine for the first die. And at block 612, the method 600 includes inputting the first external key into the first die to unlock the first die, wherein the first external key hashed with the internal chip fingerprint key creates an unlocking key for the logic lock for the first die.

Additional processes may also be included. It should be understood that the processes depicted in FIG. 6 represent illustrations, and that other processes may be added or existing processes may be removed, modified, or rearranged without departing from the scope and spirit of the present disclosure.

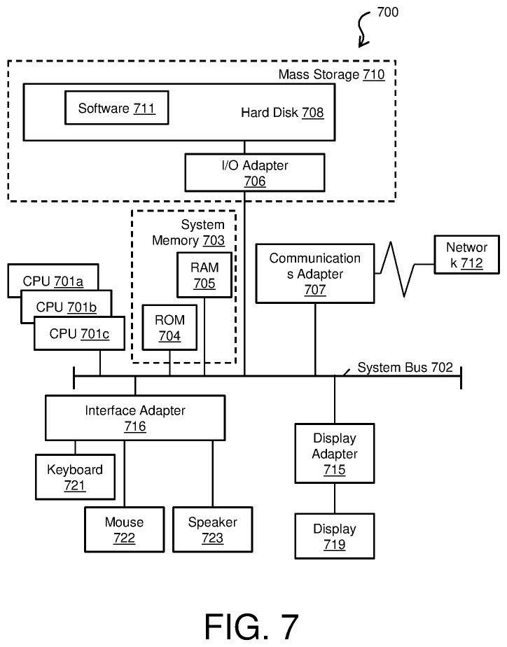

Turning now to FIG. 7, a computer system 700 is generally shown in accordance with an embodiment. The computer system 700 can be an electronic, computer framework comprising and/or employing any number and combination of computing devices and networks utilizing various communication technologies, as described herein. The computer system 700 can be easily scalable, extensible, and modular, with the ability to change to different services or reconfigure some features independently of others. The computer system 700 may be, for example, a server, desktop computer, laptop computer, tablet computer, or smartphone. In some examples, computer system 700 may be a cloud computing node. Computer system 700 may be described in the general context of computer system executable instructions, such as program modules, being executed by a computer system. Generally, program modules may include routines, programs, objects, components, logic, data structures, and so on that perform particular tasks or implement particular abstract data types. Computer system 700 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 7, the computer system 700 has one or more central processing units (CPU(s)) 701a, 701b, 701c, etc. (collectively or generically referred to as processor(s) 701). The processors 701 can be a single-core processor, multi-core processor, computing cluster, or any number of other configurations. The processors 701, also referred to as processing circuits, are coupled via a system bus 702 to a system memory 703 and various other components. The system memory 703 can include a read only memory (ROM) 704 and a random access memory (RAM) 705. The ROM 704 is coupled to the system bus 702 and may include a basic input/output system (BIOS), which controls certain basic functions of the computer system 700. The RAM is read-write memory coupled to the system bus 702 for use by the processors 701. The system memory 703 provides temporary memory space for operations of said instructions during operation. The system memory 703 can include random access memory (RAM), read only memory, flash memory, or any other suitable memory systems.

The computer system 700 comprises an input/output (I/O) adapter 706 and a communications adapter 707 coupled to the system bus 702. The I/O adapter 706 may be a small computer system interface (SCSI) adapter that communicates with a hard disk 708 and/or any other similar component. The I/O adapter 706 and the hard disk 708 are collectively referred to herein as a mass storage 710.

Software 711 for execution on the computer system 700 may be stored in the mass storage 710. The mass storage 710 is an example of a tangible storage medium readable by the processors 701, where the software 711 is stored as instructions for execution by the processors 701 to cause the computer system 700 to operate, such as is described herein below with respect to the various Figures. Examples of computer program product and the execution of such instruction is discussed herein in more detail. The communications adapter 707 interconnects the system bus 702 with a network 712, which may be an outside network, enabling the computer system 700 to communicate with other such systems. In one embodiment, a portion of the system memory 703 and the mass storage 710 collectively store an operating system, which may be any appropriate operating system, such as the z/OS or AIX operating system from IBM Corporation, to coordinate the functions of the various components shown in FIG. 7.

Additional input/output devices are shown as connected to the system bus 702 via a display adapter 715 and an interface adapter 716 and. In one embodiment, the adapters 706, 707, 715, and 716 may be connected to one or more I/O buses that are connected to the system bus 702 via an intermediate bus bridge (not shown). A display 719 (e.g., a screen or a display monitor) is connected to the system bus 702 by a display adapter 715, which may include a graphics controller to improve the performance of graphics intensive applications and a video controller. A keyboard 721, a mouse 722, a speaker 723, etc. can be interconnected to the system bus 702 via the interface adapter 716, which may include, for example, a Super I/O chip integrating multiple device adapters into a single integrated circuit. Suitable I/O buses for connecting peripheral devices such as hard disk controllers, network adapters, and graphics adapters typically include common protocols, such as the Peripheral Component Interconnect (PCI). Thus, as configured in FIG. 7, the computer system 700 includes processing capability in the form of the processors 701, and, storage capability including the system memory 703 and the mass storage 710, input means such as the keyboard 721 and the mouse 722, and output capability including the speaker 723 and the display 719.

In some embodiments, the communications adapter 707 can transmit data using any suitable interface or protocol, such as the internet small computer system interface, among others. The network 712 may be a cellular network, a radio network, a wide area network (WAN), a local area network (LAN), or the Internet, among others. An external computing device may connect to the computer system 700 through the network 712. In some examples, an external computing device may be an external webserver or a cloud computing node.

It is to be understood that the block diagram of FIG. 7 is not intended to indicate that the computer system 700 is to include all of the components shown in FIG. 7. Rather, the computer system 700 can include any appropriate fewer or additional components not illustrated in FIG. 7 (e.g., additional memory components, embedded controllers, modules, additional network interfaces, etc.). Further, the embodiments described herein with respect to computer system 700 may be implemented with any appropriate logic, wherein the logic, as referred to herein, can include any suitable hardware (e.g., a processor, an embedded controller, or an application specific integrated circuit, among others), software (e.g., an application, among others), firmware, or any suitable combination of hardware, software, and firmware, in various embodiments.

Various embodiments of the invention are described herein with reference to the related drawings. Alternative embodiments of the invention can be devised without departing from the scope of this invention. Various connections and positional relationships (e.g., over, below, adjacent, etc.) are set forth between elements in the following description and in the drawings. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

One or more of the methods described herein can be implemented with any or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

In some embodiments, various functions or acts can take place at a given location and/or in connection with the operation of one or more apparatuses or systems. In some embodiments, a portion of a given function or act can be performed at a first device or location, and the remainder of the function or act can be performed at one or more additional devices or locations.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The present disclosure has been presented for purposes of illustration and description, but is not intended to be exhaustive or limited to the form disclosed. Many modifications and variations will be apparent to those of ordinary skill in the art without departing from the scope and spirit of the disclosure. The embodiments were chosen and described in order to best explain the principles of the disclosure and the practical application, and to enable others of ordinary skill in the art to understand the disclosure for various embodiments with various modifications as are suited to the particular use contemplated.

The diagrams depicted herein are illustrative. There can be many variations to the diagram or the steps (or operations) described therein without departing from the spirit of the disclosure. For instance, the actions can be performed in a differing order or actions can be added, deleted or modified. Also, the term “coupled” describes having a signal path between two elements and does not imply a direct connection between the elements with no intervening elements/connections therebetween. All of these variations are considered a part of the present disclosure.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” are understood to include any integer number greater than or equal to one, i.e. one, two, three, four, etc. The terms “a plurality” are understood to include any integer number greater than or equal to two, i.e. two, three, four, five, etc. The term “connection” can include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instruction by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

What is claimed is:

1. A method comprising:
measuring, by a processor, characteristic data of a structure in a first die of a wafer during fabrication, wherein the characteristic data of the structure comprises a current or capacitance measurement in the structure;
recording the current or capacitance measurement as an internal chip fingerprint key for the first die;
causing, by the processor, completion of fabrication of the first die in the wafer, wherein the first die comprises a hashing engine and a logic lock;
generating a die identification (ID) for the first die based on the internal chip fingerprint key for the first die;
generating a first external key based on the die ID and the hash engine for the first die; and
inputting the first external key into the first die to unlock the first die, wherein the first external key hashed with the internal chip fingerprint key creates an unlocking key for the logic lock for the first die.

2. The method of claim 1, further comprising:
measuring second characteristic data of a second structure in a second die of the wafer during fabrication, wherein the second characteristic data of the second structure comprises a second current or capacitance measurement in the second structure;
recording the second current or capacitance measurement as a second internal chip finger print key for the second die, wherein the second die comprises a second hashing engine and a second logic lock;
generating a second die identification (ID) for the second die based on the second internal chip finger print key for the second die;
generating a second external key based on the second die ID and the second hash engine for the second die; and
inputting the second external key into the second die to unlock the second die, wherein the second external key hashed with the second internal chip finger print key creates a second unlocking key for the second logic lock for the second die.

3. The method of claim 1, wherein the structure in the first die of the wafer comprises:
a first line in a first layer of the wafer, wherein the first line has a first terminal connected to the first line;
a second line in the first layer of the wafer, wherein the second line has a second terminal connected to the second line; and
a third line in the first layer of the wafer, wherein the third line has a third terminal connected to the third line.

4. The method of claim 3, wherein measuring the characteristic data of the structure in the first die of the wafer comprises:
applying a voltage to the second terminal connected to the second line;
measuring a first resultant voltage at the first terminal connected to the first line;
measuring a second resultant voltage at the third terminal connected to the third line; and
calculating the capacitance measurement based on the first resultant voltage and the second resultant voltage.

5. The method of claim 4, further comprising:
measuring second characteristic data of a second structure in the first die of the wafer during fabrication, wherein the second characteristic data of the second structure comprises a second capacitance measurement in the second structure;
recording the second capacitance measurement as a second internal chip fingerprint key for the first die, wherein generating the die ID for the first die is further based on the second internal chip fingerprint key for the first die.

6. The method of claim 1, wherein the logic lock comprises a set of gates comprising at least one of an XOR gate and an XNOR gate.

7. The method of claim 1, wherein the die ID comprises at least one of a bar code and e-fuse.

8. A system comprising:
a memory having computer readable instructions; and
one or more processors for executing the computer readable instructions, the computer readable instructions controlling the one or more processors to perform operations comprising:
measuring characteristic data of a structure in a first die of a wafer during fabrication, wherein the characteristic data of the structure comprises a current or capacitance measurement in the structure;
recording the current or capacitance measurement as an internal chip fingerprint key for the first die;
causing completion of fabrication of the first die in the wafer, wherein the first die comprises a hashing engine and a logic lock;
generating a die identification (ID) for the first die based on the internal chip fingerprint key for the first die;
generating a first external key based on the die ID and the hash engine for the first die; and
inputting the first external key into the first die to unlock the first die, wherein the first external key hashed with the internal chip fingerprint key creates an unlocking key for the logic lock for the first die.

9. The system of claim 8, wherein the operations further comprise:
measuring second characteristic data of a second structure in a second die of the wafer during fabrication, wherein the second characteristic data of the second structure comprises a second capacitance measurement in the second structure;
recording the second capacitance measurement as a second internal chip finger print key for the second die, wherein the second die comprises a second hashing engine and a second logic lock;
generating a second die identification (ID) for the second die based on the second internal chip finger print key for the second die;
generating a second external key based on the second die ID and the second hash engine for the second die; and
inputting the second external key into the second die to unlock the second die, wherein the second external key hashed with the second internal chip finger print key creates a second unlocking key for the second logic lock for the second die.

10. The system of claim 8, wherein the structure in the first die of the wafer comprises:
a first line in a first layer of the wafer, wherein the first line has a first terminal connected to the first line;
a second line in the first layer of the wafer, wherein the second line has a second terminal connected to the second line; and
a third line in the first layer of the wafer, wherein the third line has a third terminal connected to the third line.

11. The system of claim 10, wherein measuring the characteristic data of the structure in the first die of the wafer comprises:
applying a voltage to the second terminal connected to the second line;
measuring a first resultant voltage at the first terminal connected to the first line;
measuring a second resultant voltage at the third terminal connected to the third line; and
calculating the capacitance measurement based on the first resultant voltage and the second resultant voltage.

12. The system of claim 11, wherein the operations further comprise:
measuring second characteristic data of a second structure in the first die of the wafer during fabrication, wherein the second characteristic data of the second structure comprises a second capacitance measurement in the second structure;
recording the second capacitance measurement as a second internal chip fingerprint key for the first die, wherein generating the die ID for the first die is further based on the second internal chip fingerprint key for the first die.

13. The system of claim 8, wherein the logic lock comprises a set of gates comprising at least one of an XOR gate and an XNOR gate.

14. The system of claim 8, wherein the die ID comprises at least one of a bar code and e-fuse.

15. A computer program product comprising a computer readable storage medium having program instructions embodied therewith, the program instructions executable by a processor to cause the processor to perform operations comprising:
measuring characteristic data of a structure in a first die of a wafer during fabrication, wherein the characteristic data of the structure comprises a current or capacitance measurement in the structure;
recording the current or capacitance measurement as an internal chip fingerprint key for the first die;
causing completion of fabrication of the first die in the wafer, wherein the first die comprises a hashing engine and a logic lock;
generating a die identification (ID) for the first die based on the internal chip fingerprint key for the first die;
generating a first external key based on the die ID and the hash engine for the first die; and
inputting the first external key into the first die to unlock the first die, wherein the first external key hashed with the internal chip fingerprint key creates an unlocking key for the logic lock for the first die.

16. The computer program product of claim 15, wherein the operations further comprise:
measuring second characteristic data of a second structure in a second die of the wafer during fabrication, wherein the second characteristic data of the second structure comprises a second capacitance measurement in the second structure;
recording the second capacitance measurement as a second internal chip finger print key for the second die, wherein the second die comprises a second hashing engine and a second logic lock;
generating a second die identification (ID) for the second die based on the second internal chip finger print key for the second die;
generating a second external key based on the second die ID and the second hash engine for the second die; and
inputting the second external key into the second die to unlock the second die, wherein the second external key hashed with the second internal chip finger print key creates a second unlocking key for the second logic lock for the second die.

17. The computer program product of claim 15, wherein the structure in the first die of the wafer comprises:
a first line in a first layer of the wafer, wherein the first line has a first terminal connected to the first line;
a second line in the first layer of the wafer, wherein the second line has a second terminal connected to the second line; and
a third line in the first layer of the wafer, wherein the third line has a third terminal connected to the third line.

18. The computer program product of claim 17, wherein measuring the characteristic data of the structure in the first die of the wafer comprises:
applying a voltage to the second terminal connected to the second line;
measuring a first resultant voltage at the first terminal connected to the first line;
measuring a second resultant voltage at the third terminal connected to the third line; and
calculating the capacitance measurement based on the first resultant voltage and the second resultant voltage.

19. The computer program product of claim 18, wherein the operations further comprise:
measuring second characteristic data of a second structure in the first die of the wafer during fabrication, wherein the second characteristic data of the second structure comprises a second capacitance measurement in the second structure;
recording the second capacitance measurement as a second internal chip fingerprint key for the first die, wherein generating the die ID for the first die is further based on the second internal chip fingerprint key for the first die.

20. The computer program product of claim 15, wherein the logic lock comprises a set of gates comprising at least one of an XOR gate and an XNOR gate, wherein the die ID comprises at least one of a bar code and e-fuse.
